(19) United States
(12) Patent Application Publication
(10) Pub. No.: US 2018/0154520 A1
(43) Pub. Date: Jun. 7, 2018

(54) CONTROL DEVICE, ROBOT, AND ROBOT SYSTEM

(71) Applicant: Seiko Epson Corporation, Tokyo (JP)

(72) Inventor: Yasuhiro SHIMODAIRA, Matsumoto (JP)

(21) Appl. No.: 15/825,734

(22) Filed: Nov. 29, 2017

(30) Foreign Application Priority Data
Dec. 5, 2016 (JP) 2016-236048

(51) Int. Cl. B25J 9/16; B25J 13/08

(52) U.S. Cl. CPC B25J 9/1633; B25J 13/085; B25J 9/1694; Y10S 901/10; Y10S 901/46; G05B 2219/39529; B25J 9/1664

(57) ABSTRACT

A control device that includes a processor that is configured to execute computer-executable instructions so as to control a robot having a force detector, wherein the processor is configured to: perform force control of the robot based on an output from the force detector; set a speed coefficient of the robot; and change setting of a virtual viscosity coefficient of the robot in the force control depending on the speed coefficient.

### BACKGROUND

### 1. Technical Field

The present invention relates to a control device, a robot, and a robot system.

### 2. Related Art

In the related art, an industrial robot that includes a robotic arm and an end effector attached to a distal end of the robotic arm has been developed. There is work involving contact with a target object as work of such a robot. For example, the work includes processing work or the like of the target object. In the processing of the target object, while an end effector of a processing tool is pressed against the target object with a predetermined force, a copying operation of moving the end effector in a processing direction is performed. In general, the copying operation is performed with force control and positional control (including speed control). However, the copying operation is performed on the target object with a good tracking property in a case of a relatively low moving speed in the processing direction. However, in a case of a high moving speed in the processing direction, a balance between the moving speed by positional control and a speed for achieving a target force in the force control is lost, and the tracking property with respect to the target object is likely to be degraded. In addition, in order to shorten takt time, it is desirable to have a high moving speed.

For example, in order to perform the copying operation at a relatively high speed, JP-A-2012-176477 discloses that positional control is performed at a relatively high speed based on a target track, the target track is corrected by repeating the control many times, and the copying operation is performed based on the corrected target track for a high speed.

However, in the control of a robot in JP-A-2012-176477, only a condition for satisfying the copying operation through one target track for the high speed is set, and a tracking property becomes too good in a case where a degree of an output of work of the robot is tried to be visually checked including a case where variations in dimensions of the target object are large, or in a case where the speed is tried to be changed, a problem arises in that it is not possible to perform the operation while a pressing force is maintained to be a constant force at the high speed, regardless of the copying operation that is performed with a constant force in a predetermined range at the low speed, and a measure for the target track correction is not provided. Further, when a program is executed step by step during the force control, a low speed operation needs to be performed because results are different based on the stop time thereof.

### SUMMARY

An advantage of some aspects of the invention is to solve at least a part of the problems described above, and the invention can be implemented in the following configuration.

A control device according to an aspect of the invention includes a processor that is configured to execute computer-executable instructions so as to control a robot having a force detector, wherein the processor that is configured to: perform force control of the driving of the robot based on an output from the force detector; set a speed coefficient of the robot; and change setting of a virtual viscosity coefficient of the robot in the force control depending on the speed coefficient.

According to the control device of the aspect of the invention, since the virtual viscosity coefficient is changed depending on the speed coefficient, it is possible to reduce an occurrence of losing balance between the speed in movement in a direction along a shape of a surface of a target object (hereinafter, referred to as a “moving speed”) and a speed for achieving a target force (pressing force). In this manner, since it is possible to adjust a parameter by decreasing a speed to the extent that it is possible to visually check work, it is possible to shorten time to reach the setting by which it is possible to realize a copying operation that is performed on the target object with a good tracking property regardless of the moving speed.

Here, the “copying operation” means an operation in which a desired portion of a robot is moved along the shape of a surface of a target object while a predetermined portion of the robot or a member held by the robot is in contact with the target object.

In the control device of the aspect of the invention, it is preferable that in a case where the processor is configured to change the setting of a first speed coefficient as the speed coefficient into a second speed coefficient as the speed coefficient which is larger than the first speed coefficient, the processor changes a first virtual viscosity coefficient as the virtual viscosity coefficient into a third virtual viscosity coefficient as the virtual viscosity coefficient which is smaller than the first virtual viscosity coefficient. It is preferable that, in a case where the processor is configured to change the setting of the first speed coefficient into a third speed coefficient as the speed coefficient which is smaller than the first speed coefficient, the processor changes the first virtual viscosity coefficient into a second virtual viscosity coefficient as the virtual viscosity coefficient which is larger than the first virtual viscosity coefficient.

With this configuration, even when the moving speed is changed by a change in the speed coefficient, it is possible to reduce the occurrence of losing the balance between the moving speed and the speed for achieving the target force, and thus it is possible to shorten the time to reach the setting by which a higher tracking property with respect to the target object is achieved in the copying operation.

In the control device of the aspect of the invention, it is preferable that the processor is configured to perform the change such that the virtual viscosity coefficient is inversely proportional to the speed coefficient.

With this configuration, regardless of the moving speed, it is possible to shorten time to reach the setting by which the tracking property with respect to the target object is further improved in the copying operation.

In the control device of the aspect of the invention, it is preferable that the processor is configured to be capable of changing the setting of a virtual mass coefficient of the robot in the force control depending on the speed coefficient.

With this configuration, even when acceleration in movement in the direction along the shape of the surface of the target object (hereinafter, referred to as “moving acceleration”) is changed by the change in the speed coefficient, it is possible to reduce the occurrence of losing the balance between the moving acceleration and the acceleration for achieving the target force, and thus it is possible to shorten the time to reach the setting by which a higher tracking property with respect to the target object is achieved in the copying operation.

In the control device of the aspect of the invention, it is preferable that the processor is configured to perform the change such that the virtual mass coefficient is inversely proportional to the speed coefficient.

With this configuration, regardless of the moving acceleration, it is possible to shorten time to reach the setting by which the tracking property with respect to the target object is further improved in the copying operation.

It is preferable that the control device of the aspect of the invention further includes: a graphic controller that displays, on a display device, a selecting portion for selecting whether or not the processor performs the change of the virtual viscosity coefficient.

With this configuration, an operator performs an operation on the selecting portion displayed on the display device, and thereby it is possible to easily set whether or not to change the virtual viscosity coefficient.

A robot according to an aspect of the invention is controlled by the control device of the aspect of the invention.

In the robot of the aspect of the invention, regardless of the moving speed, it is possible to shorten time to reach the setting by which the copying operation is appropriately performed with a good tracking property with respect to the target object.

A robot system according to an aspect of the invention includes: the control device of the aspect of the invention; and a robot that is controlled by the control device and has a force detector.

In the robot system of the aspect of the invention, regardless of the moving speed, it is possible to shorten time to reach the setting by which the copying operation is appropriately performed with a good tracking property with respect to the target object.

### BRIEF DESCRIPTION OF THE DRAWINGS

The invention will be described with reference to the accompanying drawings, wherein like numbers reference like elements.

FIG. 1 is a side view schematically illustrating a robot system according to an embodiment of the invention.

FIG. 2 is a block diagram of a system configuration of the robot system illustrated in FIG. 1.

FIG. 3 is a view illustrating an example of a copying operation of the robot illustrated in FIG. 1.

FIG. 4 is a view schematically illustrating the copying operation of the robot illustrated in FIG. 1.

FIG. 5 is a view schematically illustrating the copying operation of the robot illustrated in FIG. 1.

FIG. 6 is a view illustrating a window for setting a speed coefficient, which is displayed on a display device illustrated in FIG. 2.

FIG. 7 is a view illustrating a window having a selecting portion which is displayed on a display device illustrated in FIG. 2.

### DESCRIPTION OF EXEMPLARY EMBODIMENTS

Hereinafter, a control device, a robot, and a robot system according to the invention will be described in detail on the basis of preferred embodiments illustrated in the accompanying figures.

### Robot System

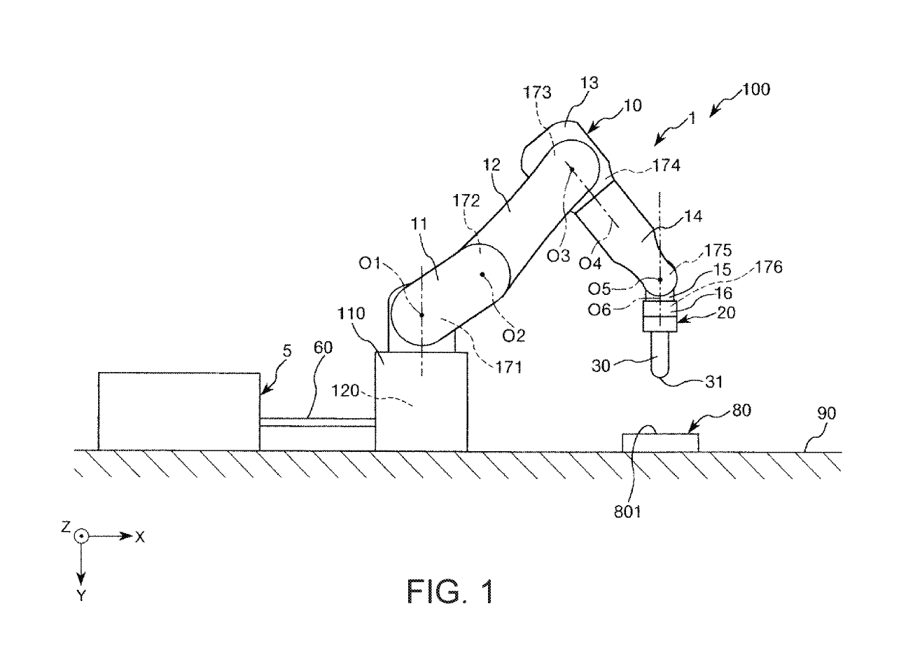

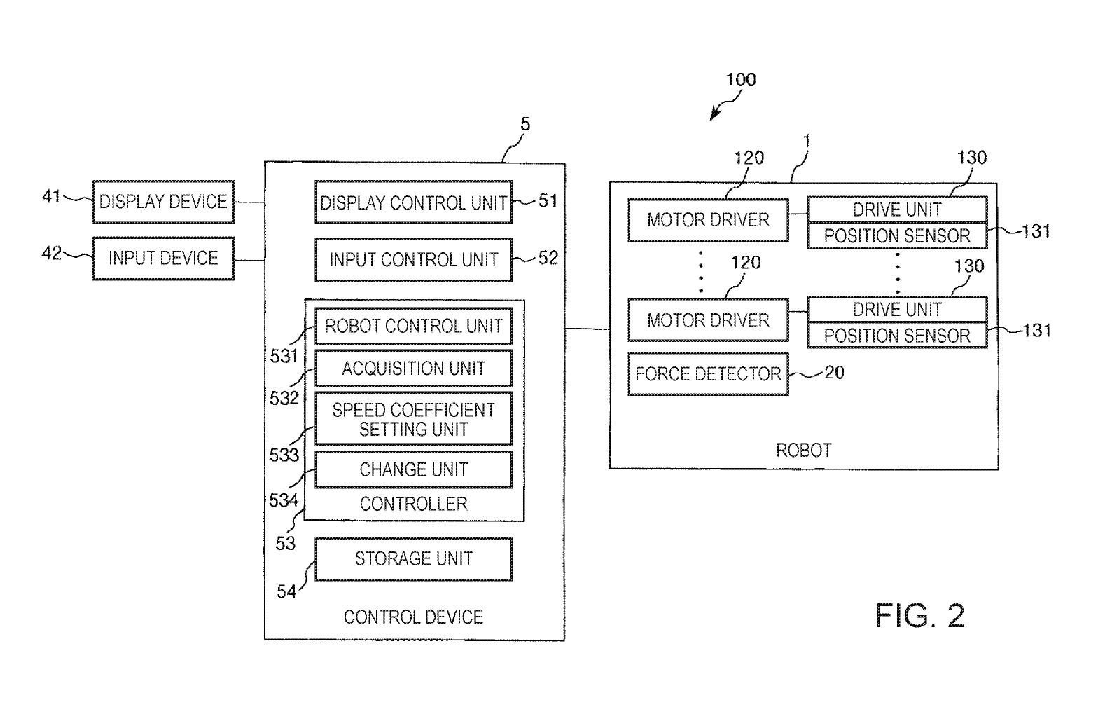

FIG. 1 is a side view schematically illustrating a robot system according to a preferred embodiment of the invention. FIG. 2 is a block diagram of a system configuration of the robot system illustrated in FIG. 1. Hereinafter, for convenience of description, in FIG. 1, an upper side is referred to as “above”, and a lower side is referred to as “below”. In addition, in FIG. 1, a base side is referred to as a “proximal end”, and an opposite side (end effector side) is referred to as a “distal end”. In addition, in FIG. 1, for convenience of description, an X axis, a Y axis, and a Z axis are illustrated as three axes orthogonal to each other. In addition, hereinafter, a direction parallel to the X axis is referred to as the “X-axis direction”, a direction parallel to the Y axis is referred to as the “Y-axis direction”, and a direction parallel to the Z axis is referred to as the “Z-axis direction”. In addition, hereinafter, the distal end side of each of arrows in the figures is referred to as “+(plus)”, and the proximal end side is referred to as “−(minus)”. In addition, an up-down direction in FIG. 1 is referred to as a “vertical direction”, and a rightward-leftward direction is referred to as a “horizontal direction”. In the specification, to be “horizontal” includes a case of the inclination with respect to the horizontal state within a range of 5° or smaller. Similarly in the specification, to be “vertical” includes a case of the inclination with respect to the vertical state within a range of 5° or smaller.

A robot system 100 illustrated in FIG. 1 includes a robot 1 and a control device 5 that controls driving of the robot 1.

### Robot

The robot 1 illustrated in FIG. 1 is a so-called six-axis vertical articulated robot. The robot 1 includes a base 110, a robotic arm 10 connected to the base 110, a force detector 20 provided on a distal portion of the robotic arm 10, and an end effector 30 provided at a distal portion of the force detector 20. In addition, as illustrated in FIG. 2, the robot 1 includes a plurality of drive units 130 that generate power (drive force) to drive the robotic arm 10, a plurality of position sensors 131, and a plurality of motor drivers 120.

While the robot 1 maintains contact with a target object 80, the robot can perform work depending on a copying operation (operation performed by impedance control) of performing movement along the shape of a surface 801 of the target object 80. Examples of the copying work include processing work such as cutting work or polishing work.

Hereinafter, each portion of the robot 1 will be described.

The base 110 is a region that attaches the robot 1 to any one of installation position 90. The installation positions of the base 110 are not limited thereto, and examples thereof include a floor, a wall, a ceiling, a movable wheeled table, or the like.

The robotic arm 10 includes a first arm 11 (arm), a second arm 12 (arm), a third arm 13 (arm), a fourth arm 14 (arm), a fifth arm 15 (arm), a sixth arm 16 (arm), and six joints 171 to 176 having a function of swingably supporting one arm with respect to the other arm (or the base 110).

The base 110 and the first arm 11 are connected to each other via the joint 171, and the first arm 11 is swingable around a first swing axis O1 with respect to the base 110 in the vertical direction. In addition, the first arm 11 and the second arm 12 are connected to each other via the joint 172, and the second arm 12 is swingable around a second swing axis O2 with respect to the first arm 11 in the horizontal direction. In addition, the second arm 12 and the third arm 13 are connected to each other via the joint 173, and the third arm 13 is swingable around a third swing axis O3 with respect to the second arm 12 in the horizontal direction. In addition, the third arm 13 and the fourth arm 14 are connected to each other via the joint 174, and the fourth arm 14 is swingable around a fourth swing axis O4 orthogonal to the third swing axis O3 with respect to the third arm 13. In addition, the fourth arm 14 and the fifth arm 15 are connected to each other via the joint 175, and the fifth arm 15 is swingable around a fifth swing axis O5 orthogonal to the fourth swing axis O4 with respect to the fourth arm 14. In addition, the fifth arm 15 and the sixth arm 16 are connected to each other via the joint 176, and the sixth arm 16 is swingable around a sixth swing axis O6 orthogonal to the fifth swing axis O5 with respect to the fifth arm 15.

Each of the joints 171 to 176 is provided with the drive unit 130 that has a deceleration device (not illustrated) that decreases the drive force of a motor (not illustrated) and a motor that generate the drive force (not illustrated), and the position sensor 131 (angle sensor) that detects a rotational angle or the like of a rotary shaft of the motor included in the drive unit 130 (refer to FIG. 2). In other words, the robot 1 includes the same number of (in the embodiment, six) the drive units 130 and the position sensors 131 as the six joints 171 to 176 (or six arms 11 to 16).

For example, a servomotor such as an AC servomotor or a DC servomotor can be used as the motor provided in the drive unit 130. For example, a planetary gear type deceleration device, a wave gear device, or the like can be used as the deceleration device provided in the drive unit 130. The position sensors 131 (angle sensors) have a function of detecting a rotating state (swinging state) of the arms 11 to 16, and an encoder, a rotary encoder, or the like can be used as the position sensor 131.

In addition, the drive unit 130 is controlled by the control device 5 via a plurality of (in the embodiment, six) motor drivers 120 which are electrically connected to the corresponding drive unit. In the embodiment, the motor drivers 120 are installed in the base 110.

As illustrated in FIG. 1, the force detector 20 is detachably attached to the distal portion of the sixth arm 16. In the embodiment, the force detector 20 is provided between the sixth arm 16 and the end effector 30. The force detector 20 is a force detector (force sensor) that detects a force (including a moment) that is applied to the end effector 30. In the embodiment, as the force detector 20, a six-axis force sensor that is capable of detecting six components of translational force components Fx, Fy, and Fz in directions of three axes (the x axis, the y axis, and the z axis) orthogonal to each other and rotating force components (moment) Mx, My, and Mz around three axes (the x axis, the y axis, and the z axis) is used. In addition, the force detector 20 outputs, to the control device 5, force detection information (for example, information of the six components described above) related to the detected forces. The force detector 20 is not limited to the six-axis force sensor and may be a three-axis force sensor or the like.

The end effector 30 illustrated in FIG. 1 is a tool that performs work on the target object 80. For example, a processing tool that performs processing such as cutting or polishing can be used as the end effector 30. A tool corresponding to work content or the like of the robot 1 may be used as the end effector 30. For example, it is possible to use a hand having a function of gripping the target object 80, an applying tool that applies paint on the target object 80, a welding tool that performs welding on the target object 80, or the like. In addition, a screw fastening tool that performs screw fastening, a fitting tool that performs fitting, or the like may be used as the end effector 30.

The robot 1 as an example of the robot according to the invention is controlled by the control device 5 which will be described below. Therefore, regardless of the moving speed, it is possible to shorten time to reach the setting by which the copying operation is appropriately performed with a good tracking property with respect to the target object 80.

Hereinafter, the control device 5 will be described.

### Control Device

In the embodiment, for example, the control device 5 may be configured to include a personal computer (PC) in which a central processing unit (CPU) being one example of a processor, a read only memory (ROM) and a random access memory (RAM) being examples of a memory for storing computer-executable instructions, and the like are installed. As illustrated in FIG. 1, the control device 5 is connected to the robot 1 via a wire 60 or the like. The robot 1 and the control device 5 may be connected to each other via wireless communication. In addition, in the embodiment, the control device 5 is provided separately from the robot 1; however, the control device may be installed in the robot 1.

As illustrated in FIG. 2, the control device 5 includes a display control unit 51, an input control unit 52, a controller 53 (processing unit), and a storage unit 54.

The display control unit 51 is connected to a display device 41 including a monitor (not illustrated) such as a display. The display control unit 51 is configured to have a graphic controller and has a function of displaying various types of images (for example, a window for operation or the like) on the monitor of the display device 41.

The input control unit 52 is connected to an input device 42 such as a mouse or a keyboard and has a function of receiving an input from the input device 42.

The input device 42 and the display device 41 described above may be integrally configured. In this case, it is possible to use a touch panel.

The controller 53 is configured to have the CPU or the like or can cause various programs to be executed by the CPU, and includes a robot controller 531 (drive control unit), an acquisition unit 532, a speed coefficient setting unit 533, and a change unit 534.

The robot control device 531 has a function of controlling the driving of the units of the robot 1. For example, the robot controller 531 has a function of outputting control signals to the drive units 130 and controlling the driving of the arms 11 to 16. In addition, in the embodiment, the robot controller 531 performs positional control (including speed control) and force control with respect to the robot 1 (robot arm 10).

Specifically, the robot controller 531 performs the positional control of driving the robot 1 such that a distal end 31 of the end effector 30 moves along a target track. More specifically, the robot controller 531 controls the driving of the drive units 130 such that positions and postures of the end effector 30 becomes positions and postures (target positions and target postures) at a plurality of target points on the target track. In addition, in the embodiment, the control is performed based on position detection information output from the position sensors 131. In addition, in the embodiment, CP control is performed as the positional control.

The robot controller 531 has a function of setting (generating) a target track and setting (generating) a position and a posture of the distal end 31 of the end effector 30, a speed (including the angular velocity) in the movement in the direction along the target track of the end effector 30, or the like.

In addition, the robot controller 531 performs the force control of controlling the robot 1 such that the end effector 30 presses (comes into contact with) the target object 80 with a target force. Specifically, the robot controller 531 controls the driving of the drive units 130 such that the force (including the moment) applied to the end effector 30 becomes the target force (including a target moment).

In addition, the robot controller 531 controls the driving of the drive units 130 based on force detection information output from the force detector 20. In addition, in the embodiment, the robot controller 531 sets, as force control, impedance (virtual mass, virtual viscosity coefficient, and virtual elastic modulus) of the distal end 31 of the end effector 30, and performs impedance control of controlling the drive units 130 such that the impedance is realized.

In the impedance control (force control), for example, Equation (1) is established for each translational direction of the x axis, the y axis, and the z axis, and Equation (2) is established for each rotational direction of the x axis, the y axis, and the z axis.

$$\begin{matrix}FCKeep ( Force control ) \text{:} TranslationalTCPSpeed ( air ) = \frac{TargetForce [ N ]}{Damper [ N \text{/} \frac{mm}{sec} ]} & ( 1 ) \\ FCKeep ( Force control ) \text{:} RotationalTCPSpeed ( air ) = \frac{TargetForce [ N \cdot mm ]}{Damper [ N \cdot mm \text{/} deg \text{/} sec ]} & ( 2 )\end{matrix}$$

TranslationalTCPspeed (air) represents a speed for achieving the target force in the translational direction in a non-contact state. RotationalTCPspeed (air) represents an angular velocity for achieving the target force (moment) in the rotational direction in the non-contact state. TargetForce is the target force, and Damper represents the virtual viscosity coefficient. Even in a case where no contact occurs, Equations (1) and (2) are satisfied. In addition, although not expressed in Equations, it is possible to calculate the acceleration and angular acceleration for achieving the target force with the target force and the virtual mass coefficient, and it is possible to calculate a displacement for achieving the target force with the target force and the virtual elastic modulus.

In addition, the robot controller 531 has a function of combining (synthesizing) a component (amount of control) related to the positional control described above and a component (amount of control) related to the force control and generating and outputting a control signal for driving the robot 1.

In the combined control (hybrid control) of the force control and the positional control by the robot controller 531 described above, for example, Equation (3) is established for each translational direction of the x axis, the y axis, and the z axis, and Equation (4) is established for each rotational direction of the x axis, the y axis, and the z axis.

$$\begin{matrix}Move ( Hybrid control ) \text{:} TranslationalTCPSpeed ( air ) = \frac{TargetForce [ N ]}{Damper [ N \text{/} \frac{mm}{sec} ]} + SpeedS ( mm / sec ) & ( 3 ) \\ Move ( Hybrid control ) \text{:} RotationalTCPSpeed ( air ) = \frac{TargetForce [ N \cdot mm ]}{Damper [ N \cdot mm \text{/} deg \text{/} sec ]} + SpeedR [ \frac{deg}{sec} ] & ( 4 )\end{matrix}$$

SpeedS represents a speed of the robot 1 by the positional control and a speed in the movement in the direction along the shape of the surface 801 of the target object 80 by the positional control of the end effector 30 (hereinafter, also referred to as a “moving speed”) in the embodiment. In addition, SpeedR represents angular velocity of the robot 1 by the positional control and angular velocity in the movement in the direction along the shape of the surface 801 of the target object 80 by the positional control of the end effector 30 (hereinafter, also referred to as a “moving angular velocity”) in the embodiment. In the specification, the moving speed and the moving angular velocity are collectively referred to as a “moving speed”. In addition, it is also possible to calculate the acceleration or the angular acceleration of the robot 1 by the hybrid control based on Equation (1) or (2) and the acceleration or the angular acceleration of the robot 1 by the positional control. In addition, it is also possible to calculate the displacement of the robot 1 by the hybrid control based on Equation (1) or (2) and the displacement of the robot 1 by the positional control.

By such hybrid control, the robot 1 can perform the copying operation of performing movement along the shape of the surface 801 while the end effector 30 is in contact with the surface 801 of the target object 80.

In addition, the acquisition unit 532 illustrated in FIG. 2 has a function of acquiring force detection information (for example, information of the six components described above) as the detection results output from the force detector 20. In addition, the acquisition unit 532 has a function of acquiring position detection information (for example, rotational angle or angular velocity of a rotational axis of the drive units 130) as the detection results output from the position sensor 131.

In addition, the speed coefficient setting unit 533 illustrated in FIG. 2 has a function of setting (changing) a speed coefficient [%] with respect to the moving speed (speed and angular velocity of the end effector 30 described above by the positional control). In this manner, it is possible to change the moving speed of the robot 1.

The speed coefficient [%] indicates a ratio (percentage) with respect to the setting speed (including the setting angular velocity) of the robot 1 and also indicates a ratio (percentage) with respect to the setting speed (including the setting angular velocity) of the end effector 30 by the positional control in the embodiment. In addition, in the embodiment, the speed coefficient can be set 0% to 1,000%.

Here, the setting speed described above is a speed at which the work is scheduled to be performed and can be arbitrarily set by an operator. The setting speed is adjusted by the speed coefficient, and thereby it is possible to obtain the moving speed that is a speed obtained when the robot 1 actually operates. The robot controller 531 performs the positional control on the drive units 130 such that the distal end 31 of the end effector 30 moves at the moving speed. For example, when the setting speed is 10 [mm/sec] and the speed coefficient is 50 [%], the moving speed as the speed obtained when the robot 1 actually operates is 5 [mm/sec].

The speed coefficient setting unit 533 sets the speed coefficient [%], and thereby the acceleration (including the angular acceleration) of the robot 1 is also set (changed) to the same percentage as the speed described above. This is because a balance between acceleration and deceleration of the operation of the robot 1 is considered.

In addition, the speed coefficient setting unit 533 is capable of collectively changing the moving speeds of the robot 1 on the entire target track or individually changing the moving speeds of the robot 1 in an arbitrary region on the target track.

In addition, the change unit 534 illustrated in FIG. 2 has a function of changing (setting) the virtual viscosity coefficient or the virtual mass coefficient of the robot 1. In the embodiment, the change unit 534 has a function of setting and holding the virtual viscosity coefficient and a function of changing the setting (resetting) of the virtual viscosity coefficient of the distal end 31 of the end effector 30 in the force control according to the speed coefficient set by the speed coefficient setting unit 533. More specifically, the change unit 534 performs the change such that the virtual viscosity coefficient has an inversely proportional relationship with the speed coefficient. For example, in a case where the speed coefficient setting unit 533 changes the setting from a first speed coefficient into a second speed coefficient which is larger than the first speed coefficient, the change unit 534 changes (resets) the first virtual viscosity coefficient to a third virtual viscosity coefficient which is smaller than the first virtual mass coefficient depending on the change. For example, in a case where the speed coefficient setting unit 533 changes the setting from the first speed coefficient into a third speed coefficient which is smaller than the first speed coefficient, the change unit 534 changes (resets) the first virtual viscosity coefficient to a second virtual viscosity coefficient which is larger than the first virtual mass coefficient depending on the change.

In addition, the change unit 534 has a function of setting and holding the virtual mass coefficient and a function of changing the setting (resetting) of the virtual mass coefficient of the distal end 31 of the end effector 30 in the force control according to the speed coefficient set by the speed coefficient setting unit 533. More specifically, the change unit 534 performs the change such that the virtual mass coefficient has an inversely proportional relationship with the speed coefficient. For example, in a case where the speed coefficient setting unit 533 changes the setting from the first speed coefficient into the second speed coefficient which is larger than the first speed coefficient, the change unit 534 changes (resets) the first virtual mass coefficient into a third virtual mass coefficient which is smaller than the first virtual mass coefficient depending on the change. For example, in a case where the speed coefficient setting unit 533 changes the setting from the first speed coefficient into the third speed coefficient which is smaller than the first speed coefficient, the change unit 534 changes (resets) the first virtual mass coefficient to a second virtual mass coefficient which is larger than the first virtual mass coefficient depending on the change.

In addition, the storage unit 54 illustrated in FIG. 2 has a function of storing a program, data, and the like for various types of processes performed by the controller 53. In addition, the storage unit 54 is capable of storing the target tracks, the force detection information output from the force detector 20, the position detection information (angle detection information) output from the position sensors 131, or the like.

As described above, a configuration of the robot system 100 is described. According to the robot system 100, regardless of the moving speed of the robot 1, it is possible to shorten time to reach the setting by which the copying operation is appropriately performed with a good tracking property with respect to the target object 80. Hereinafter, features will be described.

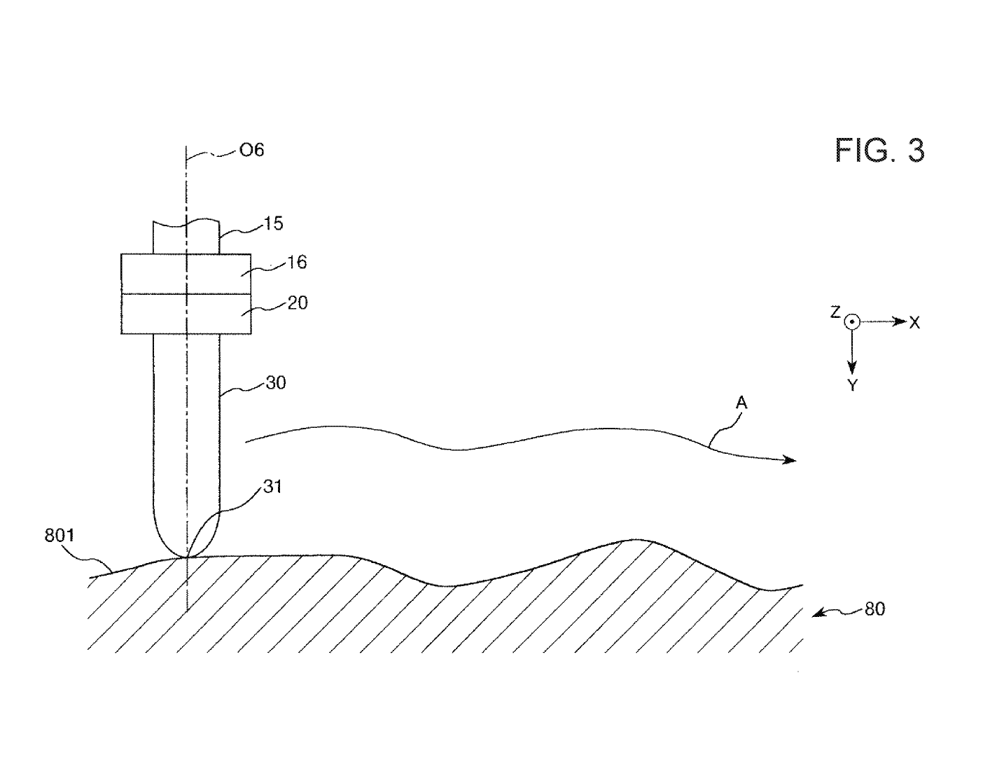

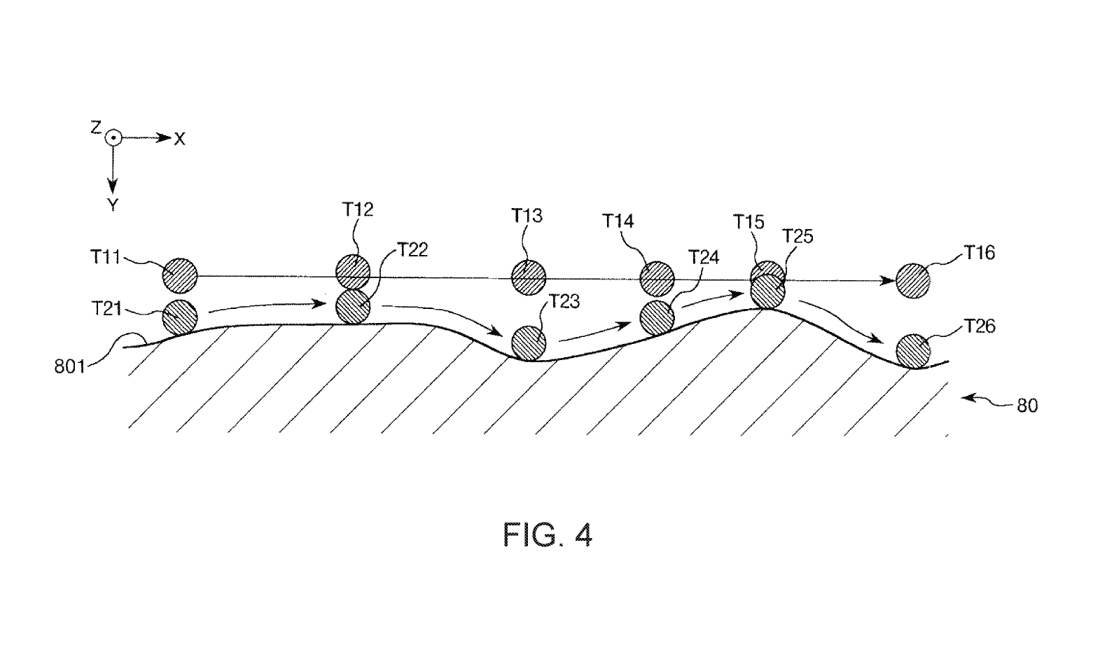

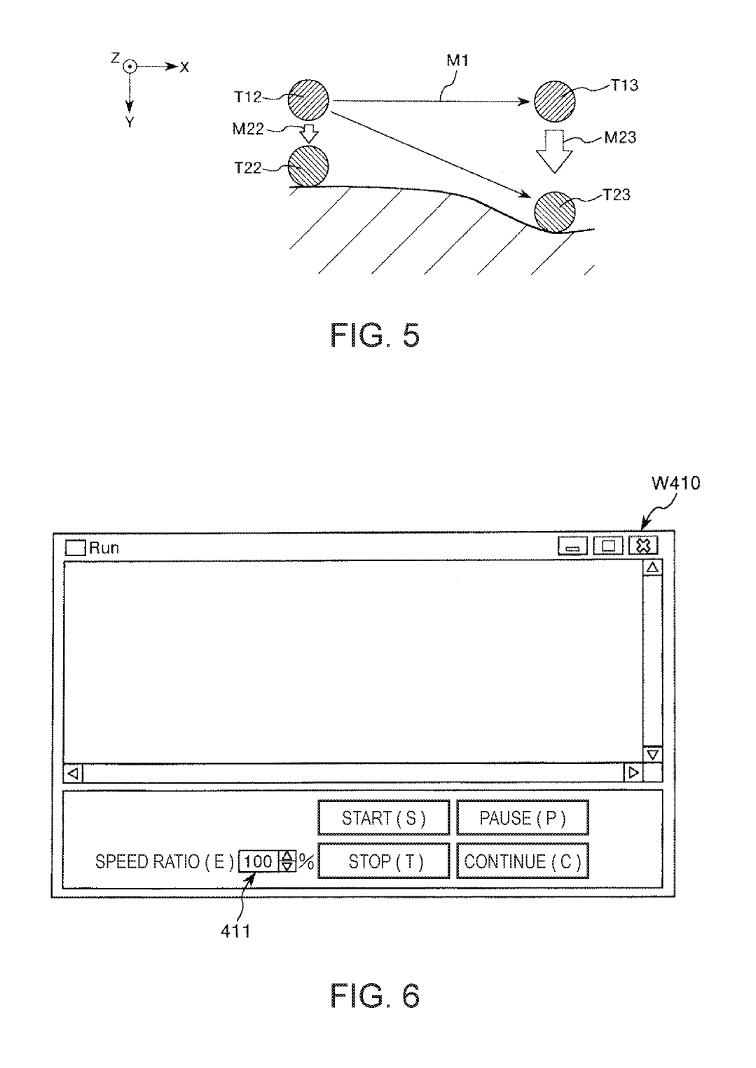

FIG. 3 is a view illustrating an example of the copying operation of the robot illustrated in FIG. 1. FIG. 4 is a view schematically illustrating the copying operation of the robot illustrated in FIG. 1. FIG. 5 is a view schematically illustrating the copying operation of the robot illustrated in FIG. 1. In FIGS. 4 and 5, the end effector 30 is schematically illustrated.

Hereinafter, as illustrated in FIG. 3, as an example, the copying operation of moving the end effector 30 in an arrow A direction along the surface 801 having an irregular shape (uneven shape) while the end effector 30 is pressed against the surface 801 of the target object 80 will be described. Here, the target track of the distal end 31 of the end effector 30 is a path along the surface 801. For example, the target track may be a path generated by CAD data or the like or may be a path or the like generated by direct teach. In addition, the target track is stored in the storage unit 54 and the driving of the components of the robot 1 for moving of the distal end 31 of the end effector 30 along the target track is to be taught.

In addition, the movement of the distal end 31 of the end effector 30 along the target track is performed by the hybrid control described above by the robot controller 531. Specifically, the movement in the +X-axis direction is performed by the positional control, and pressing (moving) in the +Y-axis direction is performed by the positional control and the force control. In other words, as illustrated in FIG. 4, an operation in which the distal end 31 of the end effector 30 moves through points T11, T12, T13, T14, T15, and T16 is performed by the positional control, and an operation, in which the distal end 31 of the end effector 30 presses the target object 80 through points T21, T22, T23, T24, T25, and T26 is performed by the positional control and the force control.

First, the setting speed is 5 mm/sec and the speed coefficient is 100% (first speed coefficient). In this manner, the moving speed is 5 mm/sec (first speed). In addition, the target force is 5 N in the force control, the virtual viscosity coefficient is 1 (first virtual viscosity coefficient), and the virtual mass coefficient is 1 (first virtual viscosity coefficient). The copying operation described above is performed in this condition, and the track of the distal end 31 of the end effector 30 is along the target track. In addition, whether the output from the force detector 20 is substantially equal to the target force of 5 N or a difference between the output and the target force is within an acceptable range is checked.

From this state, while the target force is maintained to 5 N in the force control, the moving speed is changed from 5 mm/sec (first speed) to 10 mm/sec (second speed), and thereby the same copying operation as above is performed at a higher moving speed. In this manner, takt time is shortened.

Specifically, the speed coefficient setting unit 533 sets the speed coefficient to 200% (second speed coefficient) that is larger than 100% (first speed coefficient). In this manner, it is possible to change the moving speed to 10 mm/sec (second speed). In addition, depending on the setting (changing) of a new speed coefficient, the change unit 534 changes the virtual viscosity coefficient to 0.5 (third virtual viscosity coefficient) which is smaller than 1 (first virtual viscosity coefficient) set in advance and changes the virtual mass coefficient to 0.5 (third virtual mass coefficient) which is smaller than 1 (first virtual mass coefficient) set in advance.

As described above, the speed coefficient setting unit 533 changes the speed coefficient to twice the coefficient and changes the moving speed to twice the speed. The change unit 534 changes the virtual viscosity coefficient and the virtual mass coefficient to a half thereof depending on the change. In other words, in the embodiment, depending on an increase in speed coefficient by the speed coefficient setting unit 533, the change unit 534 decreases both of the virtual viscosity coefficient and the virtual mass coefficient such that the coefficients have an inversely proportional relationship with the speed coefficient (or the moving speed). In this manner, it is possible to increase the speed and the acceleration for achieving the target force by the force control. Therefore, even when the moving speed is 10 mm/sec, it is possible to exhibit the same tracking characteristics as the copying operation in which the moving speed is 5 mm/sec.

Here, the speed for achieving the target force by the force control is not changed by tracking the change in the moving speed in a case where the change by the change unit 534 is not performed. In other words, the speed for achieving the target force by the force control is independent from the moving speed by the positional control. Therefore, in a case where the change unit 534 described above is not provided, as illustrated in FIG. 5, tracking of the speed for achieving the target force which is the pressing forces in arrow M22 and M23 directions is not performed and the speed is not increased even when the moving speed in an arrow M1 direction is increased, and thus the balance between the speeds is lost. As a result, the tracking property on the target object 80 is likely to be degraded. The same is true of the acceleration. In this respect, in the embodiment, the change unit 534 changes both of the virtual viscosity coefficient and the virtual mass coefficient depending on the change in the speed coefficient, and thereby the speed and the acceleration for achieving the target force are changed depending on the change in the moving speed. Therefore, according to the embodiment, it is possible to reduce the occurrence of the loss of the balance between the moving speed by the movement control and the speed for achieving the target force by the force control, and it is possible to move the end effector 30 from the point T22 to the point T23 with a good tracking property. As a result, as described above, even in the copying operation in which the moving speed is 10 mm/sec, it is possible to exhibit the same tracking characteristics as the copying operation in which the moving speed is 5 mm/sec. In addition, according to the embodiment, it is possible to save time and effort in the adjustment of work realization depending on the speed change.

In addition, while the target force is maintained to 5 N in the force control, the moving speed is changed from a state of 5 mm/sec (first speed) to 2.5 mm/sec (third speed), and thereby the same copying operation as above can be performed at a lower moving speed. The copying operation at such a relatively lower moving speed is appropriate in a case where the copying operation needs to be checked or the like.

Specifically, the speed coefficient setting unit 533 sets the speed coefficient to 50% (third speed coefficient) which is smaller than 100% (first speed coefficient). In this manner, it is possible to change the moving speed to 2.5 mm/sec (third speed). In addition, depending on the setting (changing) of the speed coefficient, the change unit 534 changes the virtual viscosity coefficient to 2 (second virtual viscosity coefficient) which is larger than 1 (first virtual viscosity coefficient) and changes the virtual mass coefficient to 2 (second virtual mass coefficient) which is larger than 1 (first virtual mass coefficient).

As described above, the speed coefficient setting unit 533 changes the speed coefficient to a half thereof and changes the moving speed to a half thereof. The change unit 534 changes the virtual viscosity coefficient and the virtual mass coefficient to twice the coefficients depending on the change. In other words, in the embodiment, depending on a decrease in speed coefficient by the speed coefficient setting unit 533, the change unit 534 increases both of the virtual viscosity coefficient and the virtual mass coefficient such that the coefficients have an inversely proportional relationship with the speed coefficient (or the moving speed). In this manner, it is possible to decrease the speed and the acceleration for achieving the target force by the force control. In this manner, even when the moving speed is 2.5 mm/sec, it is possible to exhibit the same tracking characteristics as the copying operation in which the moving speed is 5 mm/sec.

In addition, the setting (changing) of the speed coefficient by the speed coefficient setting unit 533 is performed depending on an instruction by an operator via a screen included in the display device 41.

FIG. 6 is a view illustrating a window for setting the speed coefficient which is displayed on the display device illustrated in FIG. 2.

The display control unit 51 displays, on the monitor of the display device 41, a window W410 for an operation, which is configured of a graphical user interface (GUI) as illustrated in FIG. 6. The window W410 has a select list 411 from which a value of the speed coefficient (speed ratio) is selected. The operator operates the select list 411 using the input device 42 and can select a value of the speed coefficient, and the speed coefficient setting unit 533 sets the speed coefficient depending on the value of the selected speed coefficient. With the window W410, the operator can easily select (set) the moving speed depending on the work content or the like by selecting the speed coefficient.

In addition, whether or not the change unit 534 changes the virtual viscosity coefficient and the virtual mass coefficient of the force control by tracking the change in the speed coefficient is determined depending on an instruction by an operator via the screen included in the display device 41.

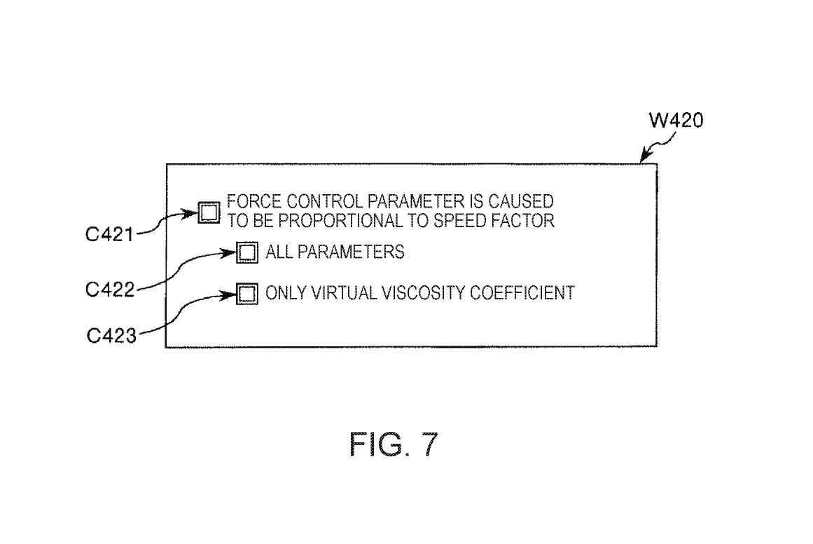

FIG. 7 is a view illustrating the window having a selecting portion which is displayed on a display device illustrated in FIG. 2.

The display control unit 51 displays, on the monitor of the display device 41, a window W420 for an operation, which is configured of the graphical user interface (GUI) as illustrated in FIG. 7. The window W420 has a checkbox C421 as the selecting portion for selecting whether or not the change of the virtual viscosity coefficient (force control parameter) and the virtual mass coefficient (force control parameter) is performed. Here, the force control parameter that is displayed on the window W420 indicates the virtual viscosity coefficient and the virtual mass coefficient. In addition, Speed Factor indicates the speed coefficient that is used for the entire operation of the robot 1 which is set in the control device 5.

In addition, the window W420 has a checkbox C422 for selecting a case where both of the virtual viscosity coefficient and the virtual mass coefficient are the content for performing the change and a checkbox C423 for selecting a case where only the virtual viscosity coefficient is the content for performing the change. Here, all of the parameters displayed on the window W420 represent the virtual viscosity coefficient, the virtual mass coefficient, and the virtual elastic modulus. The window W420 may have a checkbox for selecting a case where only the virtual mass coefficient is the content for performing the change.

For example, the operator inputs checks in the checkboxes C421 and C422 (operation) using the input device 42, and thereby the change unit 534 exhibits a function of changing the virtual viscosity coefficient and the virtual mass coefficient depending on the setting (changing) of the speed coefficient. When the check is input into the checkbox C422, the virtual elastic modulus is also changed based on the Speed Factor.

For example, the operator inputs checks in the checkboxes C421 and C423 (operation) using the input device 42, and thereby the change unit 534 exhibits a function of changing the virtual viscosity coefficient depending on the setting (changing) of the speed coefficient.

As described above, the control device 5 includes the display control unit 51 that displays, on a “display device 41” as a “display unit”, the window W420 having the checkbox C421 as the “selecting portion” for selecting whether or not the change unit 534 performs the change of the virtual viscosity coefficient. In this manner, the operator operates the checkbox C421 or the like of the window W420, and thereby it is possible to easily set whether or not each of the virtual viscosity coefficient and the virtual mass coefficient is changed depending on the setting (changing) of the speed coefficient.

As described above, characteristics related to shortening time to reach the setting by which the copying operation is appropriately performed with a good tracking property by the robot system 100 are described.

As described above, the control device 5 as an example of the control device according to the invention controls the driving of the robot 1 having the force detector 20. The control device 5 includes the robot controller 531 that performs force control of the driving of the robot 1 based on an output from the force detector 20; the speed coefficient setting unit 533 that sets the speed coefficient of the robot 1; and the change unit 534 that changes setting of the virtual viscosity coefficient of the robot 1 in the force control depending on the speed coefficient. According to the control device 5, since the virtual viscosity coefficient is changed depending on the speed coefficient, it is possible to reduce an occurrence of losing the balance between the speed (moving speed) in movement in a direction (+X-axis direction) along the shape of the surface 801 of the target object 80 and the speed for achieving the target force which is a pressing force in the +Y-axis direction. In this manner, regardless of the moving speed, it is possible to shorten time to reach the setting by which the copying operation is performed with a good tracking property with respect to the target object 80.

In addition, in a case where the speed coefficient setting unit 533 changes the setting of the first speed coefficient (for example, 100%) as the speed coefficient into the second speed coefficient (for example, 200%) as the speed coefficient which is larger than the first speed coefficient, the change unit 534 changes the first virtual viscosity coefficient (for example, 1) as the virtual viscosity coefficient into the third virtual viscosity coefficient (for example, 0.5) as the virtual viscosity coefficient which is smaller than the first virtual viscosity coefficient. In addition, in a case where the speed coefficient setting unit 533 changes the setting of the first speed coefficient into the third speed coefficient (for example, 50%) as the speed coefficient which is smaller than the first speed coefficient, the change unit 534 changes the first virtual viscosity coefficient into the second virtual viscosity coefficient (for example, 2) as the virtual viscosity coefficient which is larger than the first virtual viscosity coefficient. In this manner, even when the moving speed is changed by a change in the speed coefficient, it is possible to reduce the occurrence of losing the balance between the moving speed and the speed for achieving the target force. As a result, regardless of the moving speed, it is possible to shorten time to reach the setting by which the high tracking property is achieved with respect to the target object 80 in the copying operation.

In particular, according to the embodiment, it is preferable that the change unit 534 performs the change such that the virtual viscosity coefficient is inversely proportional to the speed coefficient. In this manner, regardless of the moving speed, it is possible to shorten time to reach the setting by which the tracking property with respect to the target object 80 is further improved in the copying operation.

In addition, the change unit 534 is capable of changing the setting of the virtual mass coefficient of the robot 1 in the force control depending on the speed coefficient. In this manner, even when the moving acceleration is changed by a change in the speed coefficient, it is possible to reduce the occurrence of losing the balance between the moving acceleration and the acceleration for achieving the target force. As a result, it is possible to shorten time to reach the setting by which the higher tracking property is achieved with respect to the target object 80 in the copying operation.

Further, in a case where the speed coefficient setting unit 533 changes the setting from the first speed coefficient (for example, 100%) to the second speed coefficient (for example, 200%) which is larger than the first speed coefficient, the change unit 534 changes the first virtual mass coefficient (for example, 1) to the third virtual mass coefficient (for example, 0.5) which is smaller than the first virtual mass coefficient. In addition, in a case where the speed coefficient setting unit 533 changes the setting from the first speed coefficient to the third speed coefficient (for example, 50%) which is smaller than the first speed coefficient, the change unit 534 changes the first virtual mass coefficient to the second virtual mass coefficient (for example, 2) which is larger than the first virtual mass coefficient. In particular, according to the embodiment, the change unit 534 performs the change such that the virtual viscosity coefficient is inversely proportional to the speed coefficient. In this manner, regardless of the moving acceleration, it is possible to shorten time to reach the setting by which the tracking property with respect to the target object 80 is improved in the copying operation.

As described above, the robot system 100 as an example of the robot system according to the invention includes the control device 5, and the robot 1 that is controlled by the control device 5 and has the force detector 20. According to the robot system 100, regardless of the moving speed, it is possible to shorten time to reach the setting by which the robot 1 appropriately performs the copying operation with good tracking property with respect to the target object 80 by the control device 5.

In addition, as an example, a case of performing the copying operation is described; however, in a case where a search operation as an operation of searching for a predetermined position of the target object 80 while the end effector 30 is in contact with the target object 80, it is effective to use the robot system 100 in the embodiment. In the search operation, for example, when the contact time is prolonged with a constant friction force (external force) generated due to the pressing of the end effector 30 against the target object 80, a force applied to the end effector 30 is increased due to the friction force. Therefore, a large difference between the actual pressing force and the detection result from the force detector 20 is generated. In a case where such a search operation is performed, the virtual viscosity coefficient is increased, and thereby it is possible to regard an influence due to the friction force equally at a high speed and at a low speed. As described above, also in the search operation, it is preferable and highly convenient that the robot 1 is driven in the control of the control device 5 in the embodiment.

As described above, the control device, the robot, and the robot system according to the invention are described on the basis of the embodiments in the figures; however, the invention is not limited thereto, and it is possible to replace the configurations of the members with any configurations having the same functions. In addition, another constituent may be added to the invention.

In addition, in the embodiment described above, the vertical articulated robot having six axes is described; however, the robot according to the invention is not limited thereto as long as the robot is configured to be controlled by the control device according to the invention and to include the movable portion and the force detector and, for example, the invention may be applied to the horizontal articulated robot.

In addition, in the embodiment described above, an example in which the force detector is provided on the distal portion of the robotic arm is described; however, the installation position of the force detector may be provided at any position as long as it is possible to detect a force or moment applied to any position of the robot. For example, the force detector may be provided in the proximal portion (between the fifth arm and the sixth arm) of the sixth arm.

The entire disclosure of Japanese Patent Application No. 2016-236048, filed Dec. 5, 2016 is expressly incorporated by reference herein.

What is claimed is:

1. A control device comprising:
a processor that is configured to execute computer-executable instructions so as to control a robot having a force detector,
wherein the processor is configured to:
perform force control of the robot based on an output from the force detector;
set a speed coefficient of the robot; and
change setting of a virtual viscosity coefficient of the robot in the force control depending on the speed coefficient.

2. The control device according to claim 1,
wherein, in a case where the processor is configured to change the setting of a first speed coefficient as the speed coefficient into a second speed coefficient as the speed coefficient which is larger than the first speed coefficient, the processor changes a first virtual viscosity coefficient as the virtual viscosity coefficient into a third virtual viscosity coefficient as the virtual viscosity coefficient which is smaller than the first virtual viscosity coefficient, and
wherein, in a case where the processor is configured to change the setting of the first speed coefficient into a third speed coefficient as the speed coefficient which is smaller than the first speed coefficient, the processor changes the first virtual viscosity coefficient into a second virtual viscosity coefficient as the virtual viscosity coefficient which is larger than the first virtual viscosity coefficient.

3. The control device according to claim 1,
wherein the processor is configured to perform the change such that the virtual viscosity coefficient is inversely proportional to the speed coefficient.

4. The control device according to claim 1,
wherein the processor is configured to be capable of changing the setting of a virtual mass coefficient of the robot in the force control depending on the speed coefficient.

5. The control device according to claim 4,
wherein the processor is configured to perform the change such that the virtual mass coefficient is inversely proportional to the speed coefficient.

6. The control device according to claim 1, further comprising:
a graphic controller displays, on a display device, a selecting portion for selecting whether or not the processor performs the change of the virtual viscosity coefficient.

7. A robot that is controlled by the control device according to claim 1.

8. A robot that is controlled by the control device according to claim 2.

9. A robot that is controlled by the control device according to claim 3.

10. A robot that is controlled by the control device according to claim 4.

11. A robot that is controlled by the control device according to claim 5.

12. A robot that is controlled by the control device according to claim 6.

13. A robot system comprising:
the control device according to claim 1; and
a robot that is controlled by the control device and has a force detector.

14. A robot system comprising:
the control device according to claim 2; and
a robot that is controlled by the control device and has a force detector.

15. A robot system comprising:
the control device according to claim 3; and
a robot that is controlled by the control device and has a force detector.

16. A robot system comprising:
the control device according to claim 4; and
a robot that is controlled by the control device and has a force detector.

17. A robot system comprising:
the control device according to claim 5; and
a robot that is controlled by the control device and has a force detector.

18. A robot system comprising:
the control device according to claim 6; and
a robot that is controlled by the control device and has a force detector.
